(19) United States
(12) Patent Application Publication
(10) Pub. No.: US 2011/0123349 A1
(43) Pub. Date: May 26, 2011

(54) NOTCHED TORQUE CONVERTER BLADE

(75) Inventor: Steven OLSEN, Wooster, OH (US)

(73) Assignee: SCHAEFFLER TECHNOLOGIES GMBH & CO. KG, Herzogenaurach (DE)

(21) Appl. No.: 12/948,467

(22) Filed: Nov. 17, 2010

Related U.S. Application Data
(60) Provisional application No. 61/263,043, filed on Nov. 20, 2009.

(51) Int. Cl. F03B 3/12

(52) U.S. Cl. 416/241 R

(57) ABSTRACT

A hydraulic torque transferring assembly comprising a shell, at least one blade installed in the shell, the blade having an inlet for receiving a flow of fluid, wherein the blade includes a notch, wherein the notch is operatively arranged to reduce a pressure that the flow of fluid exerts on the inlet, and wherein the assembly is for a turbine or an impeller in a torque converter.

### CROSS-REFERENCE TO RELATED APPLICATIONS

This application claims the benefit under 35 U.S.C. §119(e) of U.S. Provisional Application No. 61/263,043, filed Nov. 20, 2009.

### FIELD OF THE INVENTION

The invention broadly relates to torque converters, more specifically to blades for impeller and turbine assemblies in torque converters, and even more particularly to a blade having a notch on an inlet for use in an impeller or turbine assembly of a torque converter.

### BACKGROUND OF THE INVENTION

Torque converters are well known in the art, typically including at least an impeller and a turbine for transferring torque between an engine and a transmission in a vehicle. As technology advances, higher capacity torque converters become possible without increasing the size of the converter. Likewise, smaller torque converters are possible, which have capacities comparable to previous, larger designs.

However, these smaller torque converters and other torque converter designs can lead to unique torque converter characteristics, which particularly can change the interaction between the turbine or impeller and the working fluid. For example, the entrance angle of the fluid into the impeller may depend at least partially on the speed ratio, interrelationship between the impeller, the stator, and the turbine, or some other characteristic unique to the particular torque converter design. Especially at low speed ratios, the working fluid is flowing in a direction that is not aligned with the direction of rotation of the blades, which increases the pressure on the inlet of each blade. That is, particularly at low speed ratios, a change in fluid flow direction generally takes place at the inlet of the impeller blades. Consequently, the pressure causes stresses in the joints between the blades and the shell. The stresses are generally greatest in the joint proximate to the tip or leading edge of the blade. If the stresses become too high, the joint may fail, damaging the torque converter.

U.S. Pat. No. 5,334,112 (Nogle et al.) shows a turbine blade having a notch at its outlet. Japanese Patent Publication No. JP11193858 (Osamu et al.) also discloses a turbine blade having a notch at its outlet. The notches are included to stop ringing or other noise due to vibration of the blades at a resonance frequency of the blades by altering how the fluid is expelled from the turbine. Heretofore, similar notches have not been used in impeller blades, nor have they been used at the inlet of either turbine or impeller blades. U.S. Pat. No. 6,226,985 (Sasse et al.) teaches long narrow slits in the inlet and outlets of impeller and turbine blades, but these slits are not suitable for reducing pressure on the inlets of the blades, but instead to bifurcate the blades into two different working profiles.

Thus, what is needed a means for reducing the pressure on the inlet of a torque converter blade, particularly if the blade is not brazed or affixed well, or the pressure on the blade is unusually high to some other unique characteristic of the torque converter, such as the interrelationship between the impeller, turbine, and stator.

### BRIEF SUMMARY OF THE INVENTION

The present invention broadly comprises a hydraulic torque transferring assembly comprising a shell, at least one blade installed in the shell, the blade having an inlet for receiving a flow of fluid, wherein the inlet includes a notch, and wherein the notch is operatively arranged to reduce a pressure that the flow of fluid exerts on the inlet. In one embodiment, a turbine comprises the hydraulic torque transferring assembly. In one embodiment, an impeller comprises the hydraulic torque transferring assembly. In one embodiment the notch occupies approximately 40-80% of a total inlet length of the blade. In one embodiment, the notch has a depth, and the depth of the notch is a distance of approximately 30-50% of the total inlet length of the blade. In one embodiment, the notch is semicircular or arcuate in shape. In one embodiment, the blade is affixed to the shell by brazing.

The current invention also broadly comprises a torque converter including the torque transferring assembly. In one embodiment, the torque converter further includes a turbine, wherein the turbine comprises the hydraulic torque transferring assembly. In one embodiment, the torque converter further includes an impeller, wherein the impeller comprises the hydraulic torque transferring assembly. In one embodiment, the inlet has a length, and the notch occupies approximately 40-80% of the length along the inlet. In one embodiment, the inlet has a length, the notch has a depth, and the depth of the notch is a distance of approximately 30-50% of the length. In one embodiment, the notch is semicircular or arcuate in shape. In one embodiment, the blade is affixed to the shell by brazing.

The current invention also broadly comprises a blade for a torque converter including an inlet for receiving a flow of fluid, a notch in the inlet operatively arranged to reduce a pressure exerted on the input edge of the blade by the flow of fluid. In one embodiment, a turbine comprises at least one such notched blade. In one embodiment, an impeller including at least one such notched blade. In one embodiment, the inlet has a length, and the notch occupies approximately 40-80% of the length along the inlet. In one embodiment, the inlet has a length, the notch has a depth, and the depth of the notch is a distance of approximately 30-50% of the length. In one embodiment, the notch is semicircular or arcuate in shape.

### BRIEF DESCRIPTION OF THE DRAWINGS

The nature and mode of operation of the present invention will now be more fully described in the following detailed description of the invention taken with the accompanying drawing figures, in which:

FIG. 1 is a cross-sectional view of a torque converter having an impeller and a turbine;

FIG. 2 is a perspective exploded view of an impeller assembly and a turbine assembly;

FIG. 3 is a front view of an impeller assembly including a plurality of notched blades;

FIG. 4 is a cross-sectional view of the impeller assembly generally taken along line 4-4 in FIG. 3;

FIG. 5 is a perspective view of a notched blade for a turbine; and,

FIG. 6 is a perspective view of a notched blade for an impeller.

### DETAILED DESCRIPTION OF THE INVENTION

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

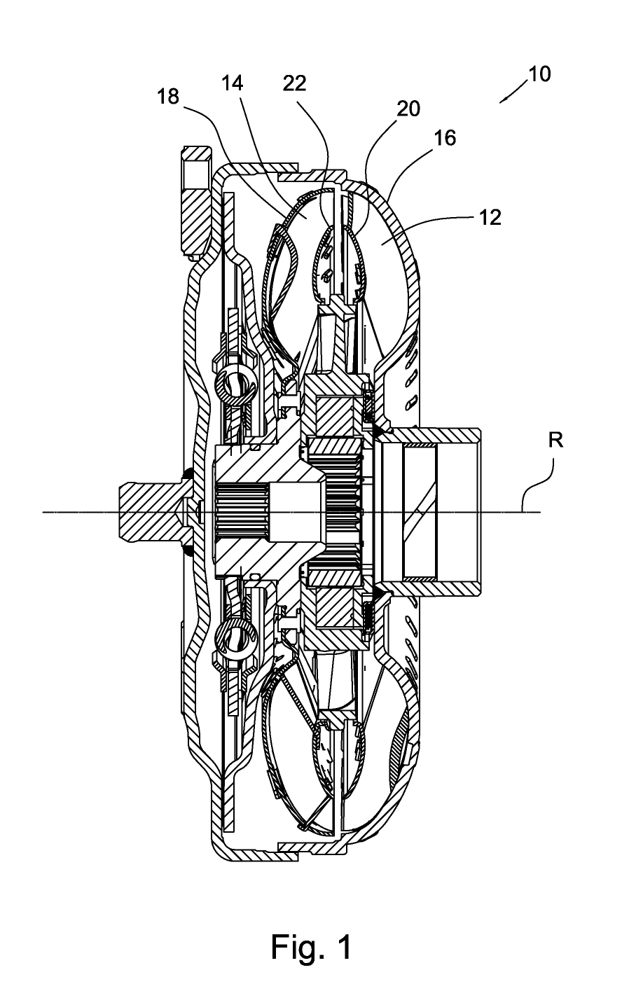

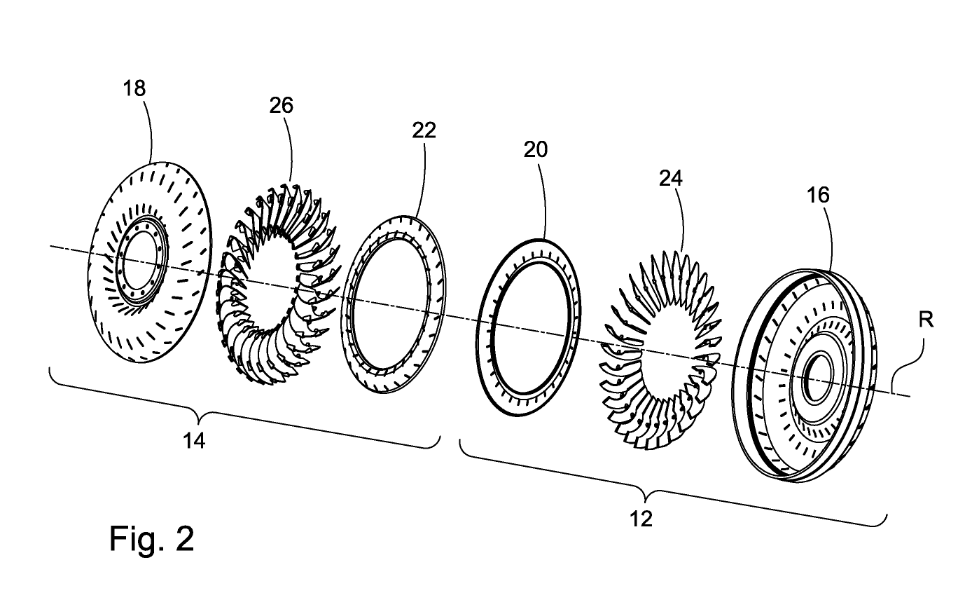

Referring now to the figures, FIG. 1 shows torque converter 10 having impeller or pump 12 and turbine 14, specifically for transferring torque between an engine and a transmission of an automobile. Impeller 12 is generally defined by impeller shell 16, while turbine 14 is generally defined by turbine shell 18. Impeller blades, such as blades 100, are mountable between shell 16 and ring 20, while turbine blades, such as blades 200, are mountable between shell 18 and ring 22. FIG. 2 shows this general arrangement with impeller blades 24 between ring 20 and shell 16, and turbine blades 26 between ring 22 and shell 18.

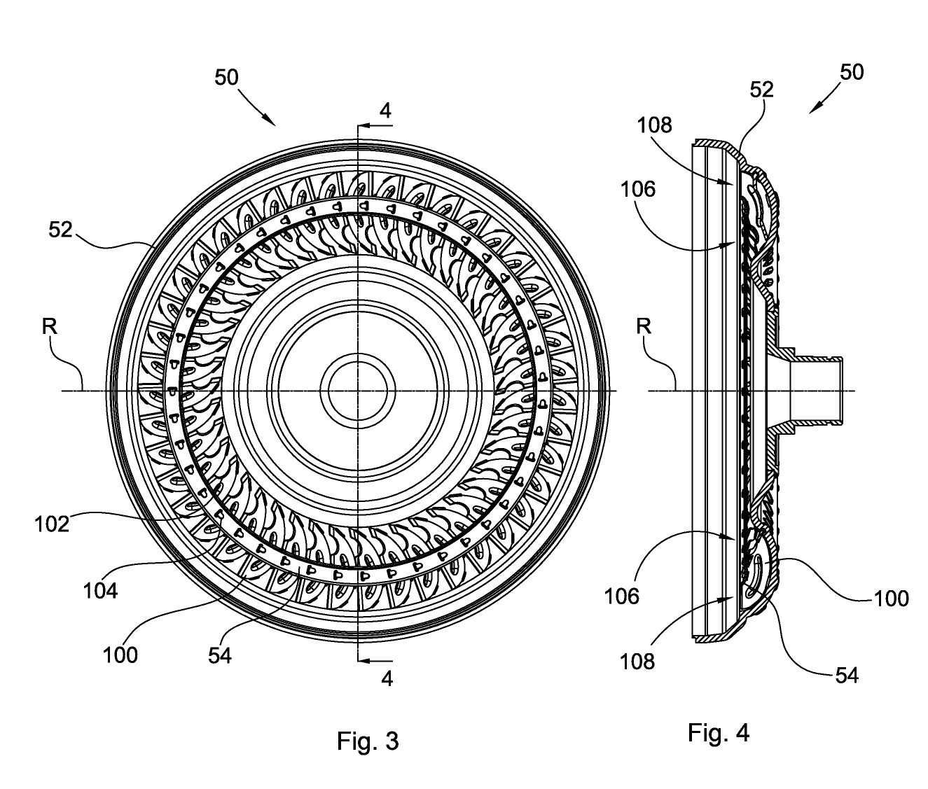

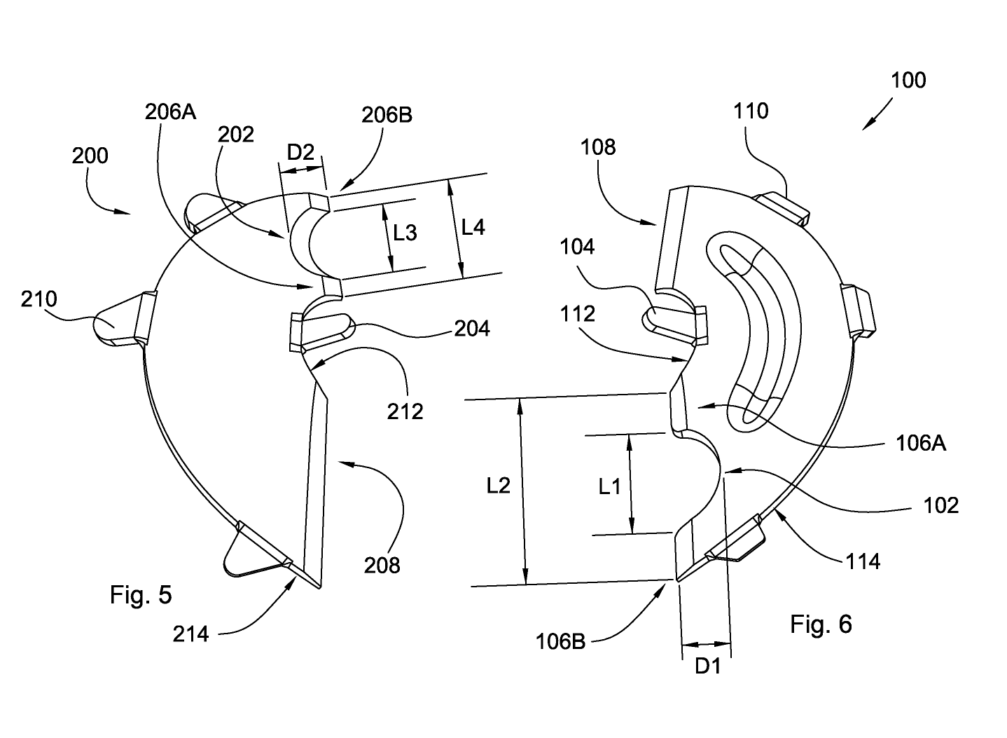

Impeller assembly 50 is shown in FIGS. 3 and 4. Assembly 50 includes shell 52 which includes a plurality of impeller blades 100 affixed therein, which blades include notches 102. Blades 100 are additionally supported by ring 54 of the assembly via tabs 104. Impeller blade 100 is shown in more detail in FIG. 6, while turbine blade 200 is shown in FIG. 5. Blade 100 receives the fluid at inlet 106; the fluid is directed by the angle of the blade in the impeller, and expelled from the blade at output edge 108 in a direction toward the turbine, where the fluid is received by inlet 206 and directed out of the turbine at outlet 208. By inlet it is meant the portion of the blade that receives the working fluid. That is, the inlet primarily comprises the leading edge or tip of the blade, but may also be generally defined to include a portion of surface of the blade proximate to the leading edge.

While other methods of affixing blades 100 to the impeller shell are possible, a common technique is by brazing. For example, in one embodiment, surface 114 of blade 100 is brazed to shell 16 and surface 112 is brazed to ring 20. Likewise, in one embodiment, surface 214 of blade 200 is brazed to shell 18, while surface 112 is brazed to ring 22. In the embodiment shown, blade 100 includes tabs 110 about outer edge 114 to assist in securing to the impeller shell, while blade 200 includes tabs 210 about outer edge 214 to assist in securing to the turbine shell.

Notch 102 in blade 100 redistributes the pressure on the inlet, particularly to reduce the stresses in the joints which affix the blade to the shell. Each notch 102 generally divides the inlet into inlet portions 106A and 106B. Advantageously, the notch reduces the total force on the inlet, and the force is concentrated near brazed edges 112 and 114. That is, instead of force applying across an entire tip or leading edge of a blade, the force is concentrated on only the ends of the leading edge. Since the force is redistributed to the inlet portions proximate to the brazed or affixed edges, the joints at these locations are better able to withstand the forces than if the fluid acted on a typical blade which did not include a notch. Advantageously, this lower pressure enables poorer quality braze joints, or typical joints in a torque converter having a unique characteristic that results in relatively large pressures, to sufficiently withstand the pressure exerted by the working fluid without failure of the joints. It should be appreciated that by reducing the pressure on the inlet, notch 102 reduces the failure rate of blades secured to the impeller shell by means other than brazing, although the notches are particularly beneficial in impellers having brazed joints.

In the embodiment shown, inlet 106 is defined in two portions on either side of notch 102 along a distance designated L2. Length L2 is generally referred to as the total inlet length, and is defined between the inner support ring and the shell, such as ring 20 and shell 16. That is, inlet length L2 is generally the length that would define the tip, leading edge, or inlet of the blade if it did not include a notch. Notch 102 occupies a distance designated L1 of the total distance L2 of the blade. In preferred embodiments, the notch occupies a substantial portion of the total inlet length. For example, it has been found that satisfactory results can generally be achieved with length L1 of notch 102 occupying between approximately 40-80% of total inlet length L2, although other ratios may work satisfactorily.

Notch 102 also has a depth designated D1, of which depth the notch extends into blade 100. In the embodiment shown, notch 102 is semicircular or arcuate in shape, so distance D2 is equal to the radius, or a portion of the radius of the semicircle. However, it should be appreciated that other shapes could be used to define notch 102. In specific preferred embodiments, depth D1 is a distance equal to approximately 30-50% of total inlet length L2 to ensure sufficient redistribution and reduction of the pressure on the inlet of the blade, although it should be appreciated that other values may work satisfactorily.

Turbine blade 200 is shown in FIG. 5. Generally, turbine blades resemble impeller blades in shape and size, since both the turbine blades and impeller blades are arranged for directing the flow of fluid through the torque converter. Blade 200 may include tab 204 for securing the blade, for example, to a turbine assembly ring, such as ring 22, and tabs 210 for securing to a turbine shell, such as shell 18. The turbine blades are also typically affixed to the shell by brazing, although other methods are known in the art.

In operation of the torque converter, the working fluid expelled from the impeller is received by the turbine. Accordingly, if impeller assembly 12 includes blades 100 and turbine assembly 14 includes blades 200, the fluid expelled by blades 100 at outlet 108 is received by turbine assembly 14, specifically at inlet 206 of blades 200. Like impeller blade 100, turbine blade 200 includes notch 202. Notch 202 is similarly included to divide the inlet into portions 206A and 206B, for reducing the total pressure exerted on the inlet portion of blade 200 by the working fluid, and concentrate the forces exerted by the working fluid on the portions near brazed edges 212 and 214. The working fluid is then transferred along blade 200 to outlet 208, where it is expelled, typically to a stator of the torque converter or back into the impeller.

In the embodiment shown, inlet 206 is defined along a distance designated L4. Distance L2 is generally referred to as the total inlet length, and is defined between the inner assembly ring, such as ring 22 and the shell, such as shell 18. That is, inlet length L4 is generally the length of the tip, leading edge, or inlet of the blade if it did not include a notch. Notch 202 occupies a distance designated L3 of the total length L4. In preferred embodiments, the notch occupies a substantial portion of the total inlet length. For example, it has been found that satisfactory results can generally be achieved with length L3 of notch 202 occupying between approximately 40-80% of total inlet length L4, although other ratios may work satisfactorily.

Notch 202 also has a depth designated D2, of which depth the notch extends into blade 200. In the embodiment shown, notch 202 is semicircular or arcuate in shape, so distance D2 is equal to the radius, or a portion of the radius of the semicircle. However, it should be appreciated that other shapes could be used to define notch 202. In specific preferred embodiments, depth D2 is a distance equal to approximately 30-50% of length L4 of the inlet to ensure sufficient redistribution of the pressure exerted by the working fluid, although it should be appreciated that other values may also work satisfactorily.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

What is claimed is:

1. A hydraulic torque transferring assembly comprising:
a shell;
at least one blade installed in said shell, said blade having an inlet for receiving a flow of working fluid, wherein said blade includes a notch, and
wherein said notch is operatively arranged to reduce a pressure that said flow of fluid exerts on said inlet.

2. A turbine comprising the hydraulic torque transferring assembly according to claim 1.

3. An impeller comprising the hydraulic torque transferring assembly according to claim 1.

4. The hydraulic torque transferring assembly recited in claim 1, wherein said notch occupies a distance of approximately 40-80% of a total inlet length of said blade.

5. The hydraulic torque transferring assembly recited in claim 1, wherein a depth of said notch is a distance of approximately 30-50% of a total inlet length of said blade.

6. The hydraulic torque transferring assembly recited in claim 1, wherein said notch is semicircular or arcuate in shape.

7. The hydraulic torque transferring assembly recited in claim 1, wherein said blade is affixed to said shell by brazing.

8. A torque converter including the torque transferring assembly recited in claim 1.

9. The torque converter recited in claim 8, further including a turbine, wherein said turbine comprises said hydraulic torque transferring assembly.

10. The torque converter recited in claim 8, further including an impeller, wherein said impeller comprises said hydraulic torque transferring assembly.

11. The torque converter recited in claim 8, wherein said notch occupies a distance of approximately 40-80% of a total inlet length of said blade.

12. The torque converter recited in claim 8, wherein a depth of said notch is a distance of approximately 30-50% of a total inlet length of said blade.

13. The torque converter recited in claim 8, wherein said notch is semicircular or arcuate in shape.

14. The torque converter recited in claim 8, wherein said blade is affixed to said shell by brazing.

15. A blade for a torque converter comprising:
an inlet for receiving a flow of working fluid; and,
a notch operatively arranged to reduce a pressure exerted on the inlet of the blade by said flow of fluid.

16. A turbine including at least one blade according to claim 15.

17. An impeller including at least one blade according to claim 15.

18. The blade recited in claim 15, wherein said notch occupies a distance of approximately 40-80% of a total inlet length of said blade.

19. The blade recited in claim 15, wherein a depth of said notch is a distance of approximately 30-50% of a total input length of said blade.

20. The blade recited in claim 15, wherein said notch is semicircular or arcuate in shape.
